(19) United States
(12) Patent Application Publication
(10) Pub. No.: US 2015/0355780 A1
(43) Pub. Date: Dec. 10, 2015

(54) METHODS AND SYSTEMS FOR INTUITIVELY REFOCUSING IMAGES

(71) Applicant: HTC CORPORATION, Taoyuan County (TW)

(72) Inventor: Hsiang-Tai Huang, Taoyuan County (TW)

(21) Appl. No.: 14/297,642

(22) Filed: Jun. 6, 2014

(51) Int. Cl. G06F 3/041; G06T 5/00; G06F 3/0488

(52) U.S. Cl. CPC G06F 3/0418; G06F 3/0412; G06F 3/0488; G06T 5/003; G06T 2207/20201; G06F 2203/04101; G06F 2203/04106

(57) ABSTRACT

Methods and systems for intuitively refocusing images are provided. First, an image is displayed on a touch-sensitive display unit, wherein the image is provided with a capability of focus adjustment. It is determined whether a contact event on the touch-sensitive display unit is detected. When a contact event is detected, the image is magnified according to a specific position where the contact event indicated on the image, and the image is refocused to the specific position.

### BACKGROUND OF THE INVENTION

1. Field of the Invention

The disclosure relates generally to methods and systems for image management, and, more particularly to methods and systems for intuitively refocusing images.

2. Description of the Related Art

Recently, portable devices, such as handheld devices, have become more and more technically advanced and multifunctional. For example, a handheld device may have telecommunications capabilities, e-mail message capabilities, image capture capabilities, an advanced address book management system, a media playback system, and various other functions. Due to increased convenience and functions of the devices, these devices have become necessities of life.

As described, a handheld device may have image capture capabilities. Currently, a function called ‘Focus Adjustment’ is provided on the portable devices, such as cameras. In an example, several images with the same scene are captured during the image capture process, wherein respective images have respective focuses at different positions corresponding to objects on the image. When the images are viewed, the image can be refocused to any position where the user selected on the image.

Additionally, a touch-sensitive screen can be equipped on the portable devices. Users can directly input data, such as controls or commands to the portable devices via the touch-sensitive screen. For example, when an image is viewed, a user can directly perform a zoom-in command via the screen, such that the image is magnified, and the magnified image is displayed on the screen.

Conventionally, if users want to see more details in the image with the capability of focus adjustment, users need to do two steps. At first, users need to zoom in the image. Secondly, users need to tap the interested area on the screen to refocus the image. It would take two steps to accomplish the user's request.

### BRIEF SUMMARY OF THE INVENTION

Methods and systems for intuitively refocusing images are provided.

In an embodiment of a method for intuitively refocusing images, an image is displayed on a touch-sensitive display unit, wherein the image is provided with a capability of focus adjustment. It is determined whether a contact event on the touch-sensitive display unit is detected. When a contact event is detected, the image is magnified according to a specific position where the contact event indicated on the image, and the image is refocused to the specific position.

An embodiment of a system for intuitively refocusing images comprises a touch-sensitive display unit and a processing unit. The touch-sensitive display unit displays an image, wherein the image is provided with a capability of focus adjustment. The processing unit determines whether a contact event on the touch-sensitive display unit is detected. When a contact event is detected, the processing unit magnifies the image according to a specific position where the contact event indicated on the image, and refocuses the image to the specific position.

In some embodiments, when a contact event is detected on the touch-sensitive display unit, the specific position of the magnified image is displayed at the center of the touch-sensitive display unit.

In some embodiments, the step of refocusing the image to the specific position comprising retrieving the image with a focus on the specific position from a plurality of the images, wherein the respective images have respective focuses at different positions.

In some embodiments, the contact event comprises a zoom-in gesture. In some embodiments, the zoom-in gesture can comprise a tap, a double tap, and/or a pinch on the touch-sensitive display unit.

Methods for intuitively refocusing images may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for intuitively refocusing images of the invention;

FIG. 2 is a flowchart of an embodiment of a method for intuitively refocusing images of the invention;

FIG. 3A is a schematic diagram illustrating an example of a touch-sensitive display unit for displaying an image; and

FIG. 3B is a schematic diagram illustrating a contact event applied on the touch-sensitive display unit of FIG. 3A according to the present invention.

### DETAILED DESCRIPTION OF THE INVENTION

Methods and systems for intuitively refocusing images are provided.

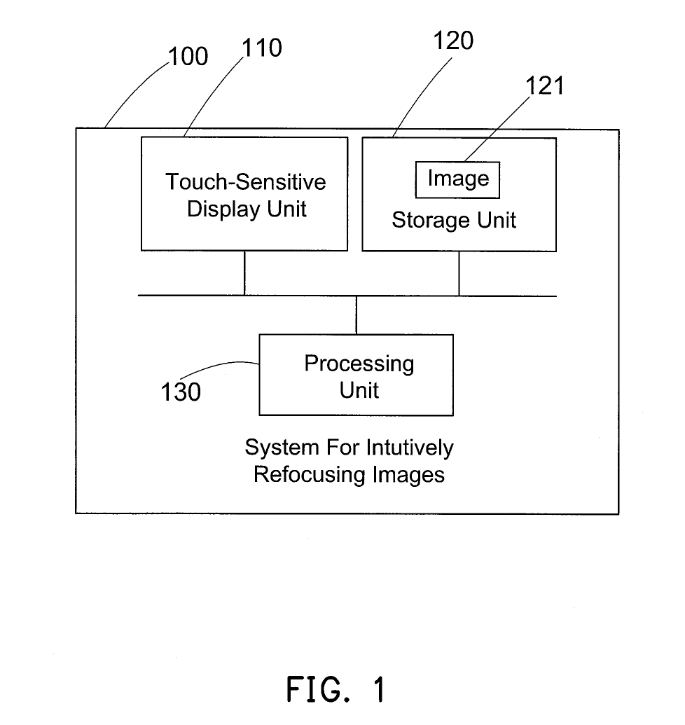

FIG. 1 is a schematic diagram illustrating an embodiment of a system for intuitively refocusing images of the invention. The system for intuitively refocusing images 100 can be used in an electronic device, such as a computer, or a portable device, such as a digital camera, a handheld device such as a mobile phone, a smart phone, a PDA (Personal Digital Assistant), a GPS (Global Positioning System), or any picture-taking device.

The system for intuitively refocusing images 100 comprises a touch-sensitive display unit 110, a storage unit 120, and a processing unit 130. The touch-sensitive display unit 110 may be a screen integrated with a touch-sensitive device (not shown). The touch-sensitive device has a touch-sensitive surface comprising sensors in at least one dimension to detect contact and movement of an input tool, such as a stylus or finger on the touch-sensitive surface. That is, users can directly input related data via the touch-sensitive display unit 110. Further, the touch-sensitive display unit 110 can display related figures and interfaces, and related data, such as images. The storage unit 120 comprises at least one image 121. It is noted that, in the embodiment, the image 121 is provided with a capability of focus adjustment. It is understood that, in some embodiments, a plurality of the images with the same scene are captured during the image capture process, wherein respective images have respective focuses at different positions corresponding to objects on the image. In some embodiments, focus information corresponding to respective objects in the image can be stored during the image capture process. It is understood that, in some embodiments, the system for intuitively refocusing images 100 can also comprise an image capture unit (not shown in FIG. 1). The image capture unit may be a CCD (Charge Coupled Device) or a CMOS (Complementary Metal-Oxide Semiconductor), placed at the imaging position for objects inside the electronic device. The image 121 can be captured via the image capture unit. The processing unit 130 can control related components of the system for intuitively refocusing images 100, process the image 121, and perform the methods for intuitively refocusing images, which will be discussed further in the following paragraphs. It is noted that, in some embodiments, the system for intuitively refocusing images 100 can further comprise a focus unit (not shown in FIG. 1). The processing unit 130 can control the focus unit to perform a focus process for at least one object during the image capture process/photography process.

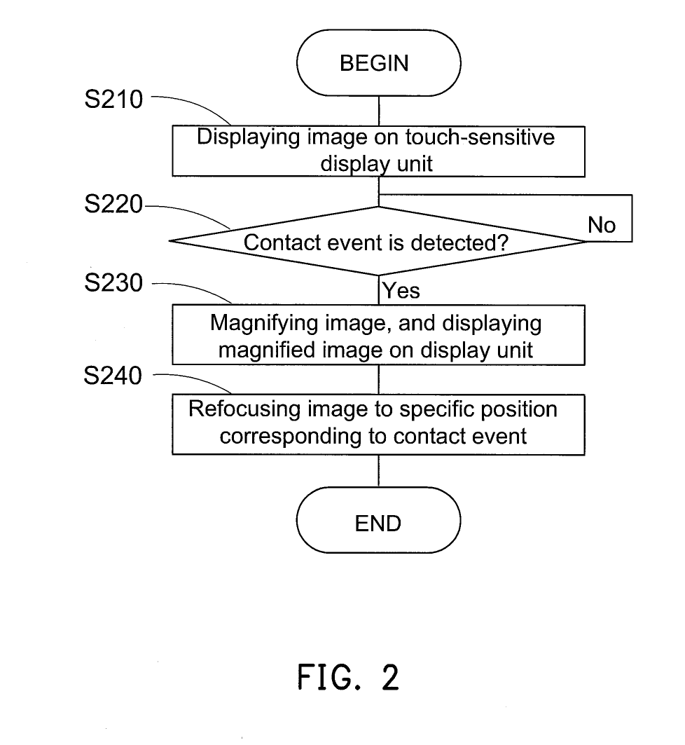

FIG. 2 is a flowchart of an embodiment of a method for intuitively refocusing images of the invention. The method for intuitively refocusing images can be used in an electronic device, such as a computer, or a portable device, such as a digital camera, a handheld device such as a mobile phone, a smart phone, a PDA, a GPS, or any picture-taking device.

In step S210, an image is displayed on a touch-sensitive display unit. It is noted that, in the embodiment, the image is provided with a capability of focus adjustment. It is understood that, in some embodiments, a plurality of the images with the same scene are captured during the image capture process, wherein respective images have respective focuses at different positions corresponding to objects on the image. In some embodiments, focus information corresponding to respective objects in the image can be stored during the image capture process. The focus information can be used for the focus adjustment of the image. In step S220, it is determined whether a contact event on the touch-sensitive display unit is detected. It is understood that, in some embodiments, the contact event may comprise a zoom-in gesture, such as a tap, a double tap, and/or a pinch on the touch-sensitive display unit. It is understood that, the above contact events are examples of the embodiment, and the present invention is not limited thereto. If no contact event is detected (No in step S220), the procedure remains at step S220. When a contact event is detected on the touch-sensitive display unit (Yes in step S220), in step S230, the image is magnified according to a specific position where the contact event indicated on the image, and in step S240, the image is refocused to the specific position. It is understood that, in some embodiments, when a contact event is detected on the touch-sensitive display unit, the specific position of the magnified image is displayed at the center of the touch-sensitive display unit. It is understood that, in some embodiments, the step of image refocusing of step S240 is performed by retrieving the image with a focus on the specific position from a plurality of the images, wherein the respective images have respective focuses at different positions. In some embodiments, the step of image refocusing of step S240 is performed by generating the image with a focus on the specific position according to the focus information corresponding to respective objects in the image, which are recorded during the image capture process.

It is understood that, in some embodiments, before the step of image refocusing of step S240, it is further determined whether the image is provided with a capability of focus adjustment. If the image is not provided with a capability of focus adjustment, the procedure is terminated. If the image is provided with a capability of focus adjustment, the step of image refocusing of step S240 is performed.

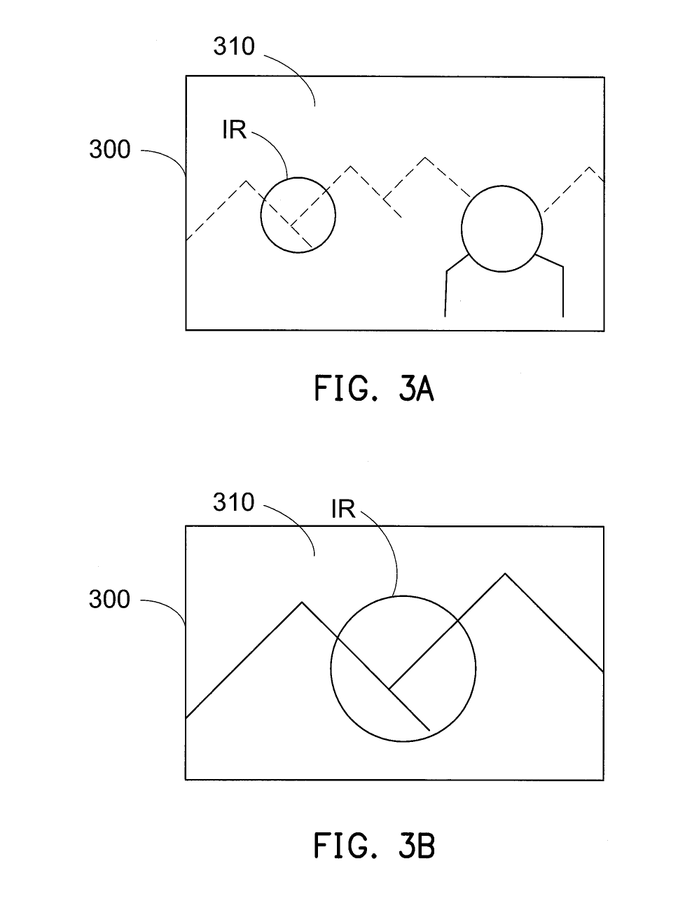

An example follows. FIG. 3A illustrates an example of a touch-sensitive display unit 300 for displaying an image 310. It is understood that, in the example, when a focus point is at an object, the object is represented by solid lines, and otherwise, the object is represented by dotted lines. When the user wants to see the more details in the interested region IR of the image 310, and the image 310 is provided with a capability of focus adjustment, the user can perform a contact event, such as a tap, a double tap, or a pinch corresponding to the interested region IR on the touch-sensitive display unit 300. Upon the contact event, the image 310 is magnified, the interested region IR of the magnified image 310 is displayed at the center of the touch-sensitive display unit 300, and the image 310 is refocused to the interested region IR, as shown in FIG. 3B.

Therefore, the methods and systems for intuitively refocusing images of the present invention can help users to magnify and refocus the image in a simple and intuitive step, thereby improving the efficiency of image process, and saving related resources, such as battery power of the electronic device.

Methods for intuitively refocusing images, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method for intuitively refocusing images for use in an electronic device, comprising:
displaying an image on a touch-sensitive display unit of the electronic device, wherein the image is provided with a capability of focus adjustment;
determining whether a contact event on the touch-sensitive display unit is detected; and
when a contact event is detected on the touch-sensitive display unit, magnifying the image according to a specific position where the contact event indicated on the image, and refocusing the image to the specific position.

2. The method of claim 1, wherein when a contact event is detected on the touch-sensitive display unit, the specific position of the magnified image is displayed at the center of the touch-sensitive display unit.

3. The method of claim 1, wherein the step of refocusing the image to the specific position comprising retrieving the image with a focus on the specific position from a plurality of the images, wherein the respective images have respective focuses at different positions.

4. The method of claim 1, wherein the contact event comprises a zoom-in gesture.

5. The method of claim 4, wherein the zoom-in gesture comprises a tap, a double tap, or a pinch on the touch-sensitive display unit.

6. A system for intuitively refocusing images for use in an electronic device, comprising:
a touch-sensitive display unit displaying an image, wherein the image is provided with a capability of focus adjustment; and
a processing unit determining whether a contact event on the touch-sensitive display unit is detected, and when a contact event is detected on the touch-sensitive display unit, magnifying the image according to a specific position where the contact event indicated on the image, and refocusing the image to the specific position.

7. The system of claim 6, wherein when a contact event is detected on the touch-sensitive display unit, the processing unit displays the specific position of the magnified image at the center of the touch-sensitive display unit.

8. The system of claim 6, further comprising a storage unit comprising a plurality of the images, wherein the respective images have respective focuses at different positions, and the processing unit refocuses the image to the specific position by retrieving the image with a focus on the specific position from the images stored in the storage unit.

9. The system of claim 6, wherein the contact event comprises a zoom-in gesture.

10. The system of claim 9, wherein the zoom-in gesture comprises a tap, a double tap, or a pinch on the touch-sensitive display unit.

11. A machine-readable storage medium comprising a computer program, which, when executed, causes a device to perform a method for intuitively refocusing images, wherein the method comprises:
displaying an image on a touch-sensitive display unit of the electronic device, wherein the image is provided with a capability of focus adjustment;
determining whether a contact event on the touch-sensitive display unit is detected; and
when a contact event is detected on the touch-sensitive display unit, magnifying the image according to a specific position where the contact event indicated on the image, and refocusing the image to the specific position.
